(19) United States
(12) Patent Application Publication
(10) Pub. No.: US 2009/0326984 A1
(43) Pub. Date: Dec. 31, 2009

(54) APPARATUS AND METHOD FOR IMPROVED ORAL HEALTH CARE

(76) Inventor: Fred S. Ferguson, East Setauket, NY (US)

Correspondence Address: THE FARRELL LAW FIRM, LLP, 290 Broadhollow Road, Suite 210E, Melville, NY, 11747, US

(21) Appl. No.: 12/437,026

(22) Filed: May 7, 2009

Related U.S. Application Data
(60) Provisional application No. 61/075,505, filed on Jun. 25, 2008.

(51) Int. Cl. G06Q 50/00; G06Q 40/00; G06Q 99/00

(52) U.S. Cl. 705/3; 705/2; 705/4; 705/10

(57) ABSTRACT

Disclosed herein is an apparatus and method for improving oral health in which a secure database is provided containing medical information specific to and updateable by a patient. The data input by the patient is authenticated at time of input and the patient is provided with real-time access to the database information to obtain suggested behavioral modifications that suggest steps for the patients to take to avoid patient illness, based on a most recent health assessment.

### PRIORITY

The application claims priority to application Ser. No. 11/113,167, filed with the U.S. Patent and Trademark Office on Apr. 25, 2005, and to application Ser. No. 61/075,505, filed with the U.S. Patent and Trademark Office on Jun. 25, 2008, the contents of each of which are incorporated herein by reference.

### BACKGROUND OF THE INVENTION

1. Field of the Invention

The present invention relates generally to a method for providing improved oral health care and, more particularly, to a method for integrating patient feedback in a managed care program to provide improved oral health at reduced cost.

2. Description of the Related Art

Medical care providers are becoming increasing cost conscious, particularly in view of the rapid escalation of medical and dental costs. Accordingly, many providers are seeking to eliminate unnecessary services. Such conventional systems, however, fail to include historical and recent behavioral trends when assessing particular patient needs. Moreover, in conventional systems the patient diagnosis is typically provided only after a patient develops an illness.

For example, Pub US 2001/0034615 to Wilkinson et al., the contents of which are incorporated herein by reference, teaches a system for facilitating collaboration among various healthcare providers. In Wilkinson et al., personalized medical information is obtained by an interactive gathering session for an initial assessment, combining patient medical, family history and other information in an integrated online system to form a “Care Team” having simultaneous access to patient data. Wilkinson et al., however, does not diagnose based on patient behavior. Nor does Wilkinson et al provide suggested behavioral modifications to improve patient health based on the patient's medical history and present patient behavior that is input by the patient, in a real time manner.

Another conventional system is described in U.S. Pat. No. 7,003,472 to Sachdeva, the contents of which are incorporated herein by reference. Sachdeva teaches a patient treatment plan that provides a list of health care services and provides a simulated treatment for orthodontic, dental and/or cosmetic care for input of information about the patient when health care services are desired. However, Sachdeva focuses on treatment of an existing symptom or illness, and fails to advise a patient of steps that can be taken to improve overall health and to be proactive in illness prevention. Sachdeva, like conventional methods, fails to provide to the patient with suggested behavioral modifications based on previously defined behavioral attributes.

U.S. Pat. No. 5,692,501 to Minturn, the contents of which are incorporated herein by reference, teaches a scientific wellness and risk quantification method based on a 10-point scientific wellness scaling and factoring formula. However, Minturn does not facilitate input by the patient, and the method of Minturn begins too late. Moreover, Minturn utilizes saliva testing that involves analysis by an external laboratory, with associated delays and cost.

The present invention overcomes the defect of conventional systems, which are primarily read-only systems that provide general responses that fail to consider the individual patient's history and behavior. To overcome this defect, the present invention utilizes an interactive, progressive and selectively accessible apparatus to provide wellness suggestions tailored to the individual patient.

The present invention overcomes an additional shortcoming of conventional systems, which typically maintain patient data only in a health care provider database or in an insurer database. Few, if any, share this data with the patient, who must overcome numerous procedural roadblocks to access his/her own data from the insurer/healthcare provider database, effectively precluding the patient from making real-time use of such data. For the few patients who maintain their own health care records, the information are typically not maintained in a consistent format and accordingly is not useable for historical trend development. Moreover, conventional systems do not access their historical data to provide a patient with suggested behavioral modifications to offset identified patient deficiencies.

The present invention overcomes such shortcomings by providing an authentication process for data input by each individual patient, and providing the patient with output from trending data obtained from comparisons with patient data and most comparable general population database information.

The authentication of the present invention provides health care providers/insurers with a mechanism to accept and utilize patient-entered data, while allowing patients to have real time access to their individual data. The present invention further assists patients by streamlining access to dental care, by providing dentists with a full patient oral health history and an automated assessment of the patient's behavioral health and oral complaints, in advance of the dental visit. The present invention allows insurers to obtain savings by reducing dental visit frequency for individuals with lower risk profiles, regular questionnaire completion, and favorable historic data.

Oral health is well recognized to be associated with overall wellness, and conventional health systems fail to utilize oral health predictors to suggest prophylactic behavioral modifications. That is, traditional health care is based on ‘treatment goals’ based on a dentist's recording of clinical findings. Often the clinical findings are based on data obtained during a single visit. However, when a patients answers questions during a dental visit, such answer are often incomplete due to memory lapse and/or dental visit stress. In addition, conventional dental practitioners do not perform a quantifiable health risk assessment, and systems do not exist to provide the dentist with a patient's oral health risk assessment prior to the patient's dental visit.

Good oral health involves a life cycle of care. Early childhood oral health prevention promotes general health, and prevents threats of common chronic illnesses. Chronic diseases also threaten oral health. Individuals, as well as their caregivers are continuously challenged to provide an appropriate level of oral care. Presently, the standard for dental care focuses on intervention, not prevention. The present invention utilizes individual risk assessments to focus preventive care. The present invention identifies behaviors that dictate oral health, identifies drivers of such behaviors, and suggests preventative measures to improve oral health.

Oral health is about knowledge and action, i.e. behavioral health and modification. Oral health care relates to general health in several ways. The present invention connects oral and general health to reduce healthcare costs and improve patient well being. The common oral illnesses—tooth decay, bleeding gums, oral malodor, and bone loss—are the most prevalent chronic health concerns that occur during a patient's entire life span. Beginning in early childhood, harmful bacteria are acquired through saliva transmission as a result of common child-care practices and interpersonal behaviors. Certain habits, lack of effective self or child-care, diet concerns and harmful lifestyle choices are among many risk concerns promoting growth of harmful mouth germs that cause common oral illnesses.

Genetics plays an important role in periodontal disease. However, environment, i.e. factors specific to an individual's situation, plays the dominant role in oral health. Evidence is growing that poor oral health impacts general health and increases risk for common chronic illness such as diabetes, cardiovascular conditions, stroke and pneumonia. There is no accurate data on serious brain impairment or death caused by abscessed teeth; however, this outcome has been documented among disadvantaged communities.

Oral health is primarily impacted by patient behavior and motivation/attitudes to seek timely dental visits, and accordingly serves as an excellent indicator of changes in patient behavior that may adversely affect overall well being. The present invention monitors patient oral health, provides timely feedback directly to the patient, suggesting behavior modifications for wellness enhancement, to obtain a lifelong collection of meaningful data.

### SUMMARY OF THE INVENTION

In preferred embodiments, aspects of the present invention solve at least the above-mentioned problems occurring in conventional systems, and the present invention allows insurers/health care providers to modify a premium paid by a patient based on the patient's participation and adherence to proactive behavior modification suggestions obtained from an interactive assessment.

An aspect of the present invention allows individual patients to utilize historical data: their own historical data, group historical data, and overall historical data; to obtain suggested behavioral modifications for improvement of their individual overall wellness. In a preferred embodiment the suggested behavioral modifications are based on comparative trends of individuals of a similar socio-economic group.

An aspect of the present invention provides incentives for the patient to adhere to Suggested Behavioral Modifications (SBMs) that inform the patient of steps to take to avoid illness and improve overall well being. In addition, the present invention allows insurers and/or payers of health care costs to verify patient compliance by providing the insurer/payer with trending data obtained from a sequence of Personalized Medical Information (PMI) received from the patient.

An aspect of the present invention promotes general health and global wellness; reduces claims; provides focused personalized and evidenced-base care; provides focused personalized, evidenced-base suggested behavioral modifications; tracks outcomes over time; promotes business development; and promotes sales of products and services.

An aspect of the present invention addresses risk behaviors related to many common health concerns, including diabetes, cardiac anomalies, obesity and lack of prenatal treatment. In preferred embodiments, businesses/sponsors are provided a method to demonstrate concern for the well being of its members, employees and families. Aspects of the present invention increase productivity, decreases missed workdays and reduces out-of-pocket health expenses, while creating autonomy and competence in the individual patient's health awareness. An aspect of present invention incorporates current health and communication initiatives to maximize patient wellness. The present invention supports the initiative of pediatric providers by creating oral health reports for pediatricians and prenatal health care providers.

### BRIEF DESCRIPTION OF THE DRAWINGS

For a better understanding of the invention as well as other objects and further features thereof, reference is made to the following detailed description to be read in conjunction with the accompanying drawings, wherein:

FIG. 1 is a flowchart showing development of contemporaneous individualized queries according to the present invention; and

FIG. 2 is a flowchart outlining patient access of the individualized queries and receipt of a behavior modification report according to the present invention.

### DETAILED DESCRIPTION OF THE PREFERRED EMBODIMENTS

The following detailed description of the preferred embodiments of the invention makes reference to the accompanying drawings. In describing the invention, explanation of related functions or constructions known in the art are omitted for the sake of clearness in understanding the concept of the invention, to avoid obscuring the description of the invention with unnecessary detail.

The present invention extracts and manipulates data obtained from a patient during a visit to oral health provider, to provide a Behavior Modification Report (BMR) 110, which is individualized for the patient and reflects present time patient needs. For example, the BMR 110 can suggest diet changes such as eating less red meat and lifestyle changes including more exercise and/or less smoking. As oral health (a daily health domain) is significantly interrelated with these common health concerns, the present invention provides information to reduce behavioral concerns significant to general health problems as well as reducing risk for common oral health problems.

A preferred embodiment of the invention solicits input from a consumer (i.e. patient) 150, a payer 190, which is often the patient's employer, and a health provider 182, which in certain embodiments can be a Health Maintenance Organization (HMO). In conventional systems, a dental examination is performed to treat an existing condition. A dentist 155 performing the examination is working with information that addresses costs that will be reimbursable for treatment of existing condition(s).

In conventional systems, the patient 150 is often unaware of reimbursable costs. In preferred embodiments of the present invention, the patient 150 is made aware of regular reimbursable costs, as well as decreased reimbursement levels that will apply upon failure of the patient 150 to adhere to Suggested Behavioral Modifications (SBMs) informing the patient 150 of steps to take to avoid illness and improve overall well being. In addition, the present invention allows insurers and/or payers of health care costs to verify patient compliance by providing the insurer/payer with trending data obtaining from a sequence of Personalized Medical Information (PMI) of the patient.

The present invention preferably provides the patient 150 with an on-line interface 140 to allow access and input by the patient 150 of data specific to the patient 150, as well as data retrieved from a plurality of persons 160 who are members of the population having common groupings of statistical socio-economic characteristics 170. Preferably, patient data is stored in a secure Internet file. Date sensitive data is stored as the patient 150 completes each questionnaire 142, and the system of the present invention compiles a patient historical database 500 of data unique to the patient 150. The questionnaire 142 is preferably interactive, allowing a person to receive an oral health risk score providing immediate feedback as to whether the patient 150 is at a high, medium or low risk for oral health problems. Reduction of such risk improves overall health.

The questionnaire questions generally fall into categories for children, adolescents and adults. In preferred embodiments, the questions are predictive, based on results of data compilations of similarly situated persons.

Users of the present invention utilize the oral health risk questionnaire to self-identify their general and oral health risk concerns. In a preferred embodiment software enables case managers to coordinate cost effective dental management and behavioral health promotion, by a culling of data to identify participant risk status, thereby significantly reducing dental claims and ongoing health care costs, particularly for diabetes, cardiac, respiratory and prenatal health, and creating an improved quality of life for participants.

In preferred embodiments, product placement advertisements are selectively embedded based on a determination of probable conditions that the patient will suffer from. The interface of the present invention also preferably allows users to access informative guides regarding protocol and treatment of various health and dental conditions.

A secure Internet folder is preferably provided for each patient, who enters age, gender and other information. Varied access is allowed to the folder, depending upon whether the patient enrolls as an individual or as enrolled a member group, such as an insurer, employer, correctional facility or school.

Health insurers and other member groups can, in a preferred embodiment, mandate access and participation to monitor behavioral trends of the insured and to control costs. Feedback obtained from dental care providers is utilized to assess veracity of entries made by the insured. Cost controls include modification of frequency of dental visits, with lower risk patients not being required and/or reimbursed for more frequent visits, while higher risk patients are mandated to visit the dentist more often. In the event that the more frequent dental visits confirm that an insured is not complying with the SBMs, the insurer will increase premiums or withdraw coverage of the insured.

Preferably additional socio-economic and demographic information are obtained for each patient, including occupation, income level, family data, age at time of marriage(s), etc. Based on such information, the patient is provided with an oral health questionnaire. As described below, the patient member will receive personalized health guidance and a report that addresses the patient's specific health concerns. Preferably, the patient is provided with automated reminders to provide updated personalized medical information at predetermined intervals that depend upon a most recent personalized risk score. In a preferred embodiment, a patient with a high risk score will be reminded to complete a questionnaire providing updated personalized medical information on three month intervals, a patient with a moderate risk score at six month intervals and a patient with low risk score at a twelve month interval.

In a preferred embodiment, the patient will receive a reminder of an upcoming dental visit, will complete a questionnaire on-line, and will confirm the dental appointment on-line. Data entered on the questionnaire is forwarded to the dentist and is compared to patient historical data. Based on the questionnaire data and a comparison with the historical data, the dentist is provided with an indication of the likely required treatment, thereby allowing the dentist to more appropriately allocate office resources, including rescheduling appointments that are believed to require additional time based on the questionnaire data.

In a preferred embodiment, the interactive questionnaire 142 is also used for assessment and input of data by caregivers, such as a dentist 155, as well as insurers 180, HMO's 182, employers 190, school districts, unions and child-care companies, and caregivers of children of enrolled patients. For example, the employer 190, who often pays the health premium, can review the patient's performance, for purposes of assessing a proper level of health care or to provide incentives for improvement by the patient. The insurer 180, HMO 182, etc. can utilize the inventive system to direct the patient to receive additional, and specific health or dental care based on information maintained in the patient historical database 500.

The questionnaire 142 is used to obtain data to assess risk behaviors that relate to common oral health problems. The Surgeon General's Oral Health Report 2003 and Oral Health America 2010 are documents that extensively demonstrate the relationship of oral to general health and wellness. In addition to the interactive questionnaire, the invention also presents the user with tools designed to enhance the user's oral health care and knowledge. Preferably, each questionnaire is tailored to the patient based on factors that include age, gender, self-care habits, dietary preferences, and health history. With age, other factors such as sleep disturbances, oral medications, smoking and alcohol use and quality of existing dental care etc become more prevalent.

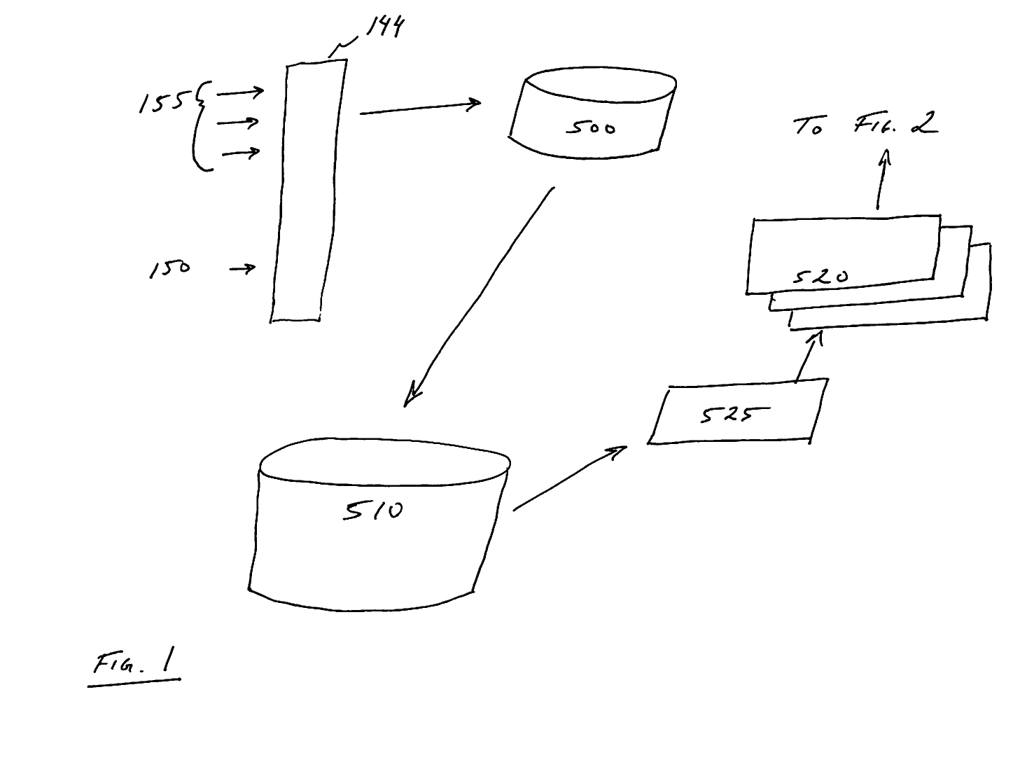

As shown in FIG. 1, a preferred embodiment allows patient 150 data to be input by a patient caregiver, such as the patient's dentist 155, general practitioner, or chiropractor, in addition to input by the patient 150. An authentication protocol 144 preferably monitors and attaches a unique source identifiers to all data input into the patient historical database 500.

In a preferred embodiment, a general population database 510 is compiled from a plurality of patient historical databases 500, with the information stored in the general population database 510 not including any information that allows for individual identification. That is, the general population database 510 preferably does not store patient names, social security numbers or the like. Rather, the general population database 510 stores health data and symptom information, which is not traceable to any specific person, thereby facilitating compilation of statistical socioeconomic characteristics without risk of inadvertent disclosure of patient identification.

Interface 140 preferably outputs information to allow the patient 150 to readily access and identify trends in the patient's health based on real-time comparison with the statistical socio-economic characteristics 170 of the plurality of persons 160. The output preferably includes a plurality of contemporaneous individualized queries 520 generated by comparing patient characteristics such as age, gender, etc., to data stored in the general population database 510 for similarly situated persons.

In a preferred embodiment of the present invention, a method is provided to access the patient's Internet file and to obtain a real-time personalized risk score 120 that provides the patient 140 with an immediate “good” or “bad” indication of present health characteristics. In a preferred embodiment, a high risk patient is provided with a an interactive indication showing pH level variation in the patient's mouth based on the time when the patient snacks, drinks water, drinks beverages that contain sugar, or smokes, thereby providing an immediate visual indicator of the negative consequence associated with over indulgence in certain activities, considering the issues associated with reduced pH levels.

The present invention preferably allows the patient to view a chronology of scores to determine whether recent a patient's behavioral modifications have resulted in an improvement or reduction overall health. Use of the present invention allows the patient to access their score, and improved scores delay or eliminate onset of disease and major illness.

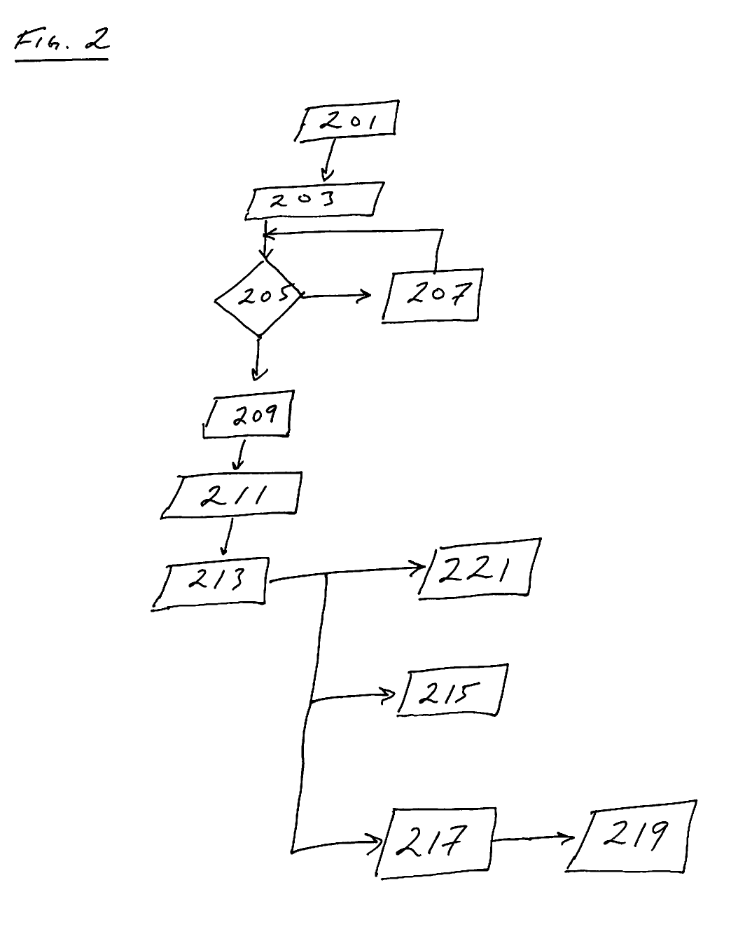

As shown in FIG. 2, in a preferred embodiment of the present invention, a patient logs in and access the patient's unique Internet file in step 201. As described in regard to FIG. 1, targeted information is obtained from the general population database 510. The targeted information is one or more contemporaneous individualized queries 520, which are formatted and presented in step 203 to the patient for response. At step 205 it is determined whether the patient 150 has adequately completed questionnaire 142. If so, at step 209 risk concerns (e.g. reduced alcohol consumption, etc.) are highlighted for consideration by the patient 150. A personalized risk score 120 is then presented, followed by sending of a Behavior Modification Report (BMR) 100 and other alerts and reports, in steps 213-221. In a preferred embodiment school administrators are provided with specific group reports demonstrating changing attitudes and knowledge of oral health care that occurs as student mature from kindergarten through twelfth grade.

The scoring preferably is provided with rated options for treating extant or imminent conditions, and is saved in the patient's unique Internet file. Comparison, by comparator 525, of the patient's present score and previously input data provides for an assessment of any changed behaviors that might lead to health concerns for the patient. The BMR 110 provides the patient 150 with actions that the patient can take to reduce risk of such predicted future ailments. Accordingly, the preferred embodiment creates and utilizes a quantifiable data set that the patient can rely on to risk assessment and proactive planning for improved help.

The interactive oral health risk assessment tool of the present invention enables individuals to develop a personal on-line secure oral health record, i.e. personalized medical information 100, and provides incentives for the individuals to allow health care providers as well as insurers access to the personalized medical information 100. A preferred embodiment entices sharing of patient database include insurers and HMOs, employer health education providers, by potentially reducing premiums and allowing medical providers preferred access.

In a preferred embodiment, timely patient reminders are provided via one or a series of emails to the patient outlining steps to be followed upon receipt of each email, wherein the steps correspond to recognized treatment for conditions identified by analysis of the patient's responses to the contemporaneous individualized queries 520.

A preferred embodiment of the present invention allows health care providers, insurers and the like to track of patient compliance with the BMRs, thereby allowing providers to obtain a patient risk assessment, and identify and potentially penalize patients who fail to comply with suggest BMRs.

While certain embodiments and structures are described herein embodying the invention, it will be obvious to those skilled in the art that various modifications, and re-arrangements of parts can be made without departing from the spirit and scope of the invention, as described by the appended claims.

What is claimed is:

1. A method for improving patient health, the method comprising:
inputting patient data into a database utilizing a series of online questionnaires completed by the patient;
monitoring, by an insurer, the patient data; and
providing suggested behavioral modifications based on a comparison of the patient data to data obtained from a general population database.

2. The method of claim 1, wherein the data obtained from the general population database for the comparison is limited to individuals of a similar socioeconomic group.

3. The method of claim 2, further comprising providing a patient risk score based on the comparison of the similar socioeconomic group data.

4. The method of claim 1, further comprising providing to the patient suggested behavioral modifications to improve patient oral health.

5. The method of claim 4, wherein the insurer modifies an insurance premium paid by the patient based on patient compliance with the suggested behavioral modifications.

6. The method of claim 5, further comprising:
inputting by a dental provider data into the database; and
utilizing the data input by the dental provider to detect patient compliance.

7. The method of claim 3, wherein the insurer modifies a frequency of approved dental visits based on the risk score.

8. The method of claim 7, wherein dental visit avoidance results in revocation or denial of insurance coverage.

9. A method for improving patient health, the method comprising:
providing an online questionnaire to each of at least two subscribing patients;
storing information input by the at least two patients on the online questionnaire;
accessing a database that stores oral healthcare information of a plurality of patients;
comparing the stored information input by one of the at least two patients with the accessed oral healthcare data; and
outputting to the one patient suggested behavioral modifications based on the comparison.

10. The method of claim 9, wherein the comparison is between data of patients of similar age and gender.

11. The method of claim 9, wherein the suggested behavioral modifications are is provided to improve oral health.

12. The method of claim 9, wherein the database includes a library of questions predictive of oral and general health.

13. The method of claim 12, wherein questions presented to the one patient focus on age and gender of the one patient.

14. The method of claim 9, further comprising sending an electronic notification of an upcoming dental visit to the one patient, wherein scheduling of the dental visit is based on a patient risk score obtained by the comparing of the stored information input by one of the at least two patients with the accessed oral healthcare data.

15. The method of claim 14, wherein personalized suggested behavioral modifications are electronically provided to the one patient based on the patient risk score.

16. The method of claim 9, wherein an insurer subscribes the one patient and the insurer monitors patient compliance with the suggested behavioral modifications.

17. A system for monitoring patient health, the system comprising:
a patient database for storing data input by a patient;
a questionnaire provided to the patient at regular intervals to obtain patient data to store in the database; and
an access portal providing an insurer access to the patient data and to a patient risk score,
wherein the patient risk score is based on a comparison of patient data to historical data of individuals in a similar socio-economic group.

18. The system of claim 17, wherein suggested behavioral modifications are provided to the patient based on the comparison.

19. The system of claim 18, wherein the insurer modifies an insurance premium based on patient compliance with the suggested behavioral modifications.

20. The system of claim 18, wherein the suggested behavioral modifications are electronically provided to the patient at regular intervals.
